(19) United States
(12) Patent Application Publication
(10) Pub. No.: US 2008/0075618 A1
(43) Pub. Date: Mar. 27, 2008

(54) Metal Powder Layered Apparatus for Downhole Use

(75) Inventors: Gary A. Martin, Sugar Land, TX (US); David J. Belliveau, Malborough, MA (US); Daniel B. Theriault, Damon, TX (US)

Correspondence Address: SCHLUMBERGER OILFIELD SERVICES, 200 GILLINGHAM LANE, MD 200-9, SUGAR LAND, TX, 77478, US

(73) Assignee: SCHLUMBERGER TECHNOLOGY CORPORATION, Sugar Land, TX (US)

(21) Appl. No.: 11/829,543

(22) Filed: Jul. 27, 2007

Related U.S. Application Data
(60) Provisional application No. 60/826,178, filed on Sep. 19, 2006.

(51) Int. Cl. B22F 7/02; E21B 1/00; G06F 19/00; G06G 7/48

(52) U.S. Cl. 419/6; 700/98; 703/7; 81/488

(57) ABSTRACT

A method for manufacturing a downhole tool includes obtaining a three-dimensional model of the downhole tool; converting the three-dimensional model of the downhole tool into a model having a plurality of two-dimensional layers; and building the downhole tool, layer-by-layer, by melting a metal powder or an alloy powder using an electron beam based on the model having a plurality of two-dimensional layers. A downhole tool manufactured by a process includes obtaining a three-dimensional model of the downhole tool; converting the three-dimensional model of the downhole tool into a model having a plurality of two-dimensional layers; and building the downhole tool, layer-by-layer, by melting a metal powder or an alloy powder using an electron beam based on the model having a plurality of two-dimensional layers.

### CROSS-REFERENCE TO RELATED APPLICATIONS

This application claims the benefits of U.S. Provisional Patent Application Ser. No. 60/826,178 filed on Sep. 16, 2006. This provisional application is incorporated by reference in its entirety.

### BACKGROUND OF INVENTION

1. Field of the Invention

This invention relates generally to methods for making tools for downhole use and tools made by these methods. More particularly, this invention relates to techniques for manufacturing parts, instruments, and components of downhole tools, using electron beam melting techniques.

2. Background Art

In oil and gas exploration and production, various tools are used downhole. Such tools are used, for example, in drilling the wells, investigating the subsurface formation properties, monitoring and production of hydrocarbons from the well. For example, in well logging or monitoring, a downhole tool, comprising a number of emitting sources and sensors for measuring various parameters, may be lowered into a borehole on the end of a cable, a wireline, a tubing string, or a drill string. Some of these tools or equipment must withstand the harsh environments downhole, which may include temperatures at 250° C. or higher and pressures of 25,000 psi or higher.

The methodology for manufacturing parts, tools, instruments, components or equipment has typically entailed some sorts of assembly or construction process. In the case of metallic apparatus, the parts have traditionally been formed in a casting or founding process. In the oil and gas industry, installments or tools for downhole use are typically formed as metallic tubulars that are used to house various types of sources, sensors, measurement equipment, sampling chambers, transmitters, etc.

FIG. 1 shows one example of a conventional downhole electromagnetic logging tool equipped with transducers. The transducers 30 are mounted in a downhole tool 100, which is disposed in a borehole 12 that penetrates an earth formation. The tool 100 also includes a multi-axial electromagnetic antenna 91 for subsurface measurements and electronics 92, 93 with appropriate circuitry. The tool 100 is shown supported in the borehole 12 by a logging cable 95 in the case of a wireline system or a drill string 95 in the case of a while-drilling system. With a wireline application, the tool 100 is raised and lowered in the borehole 12 by a wench (not shown), which is controlled by surface equipment 98. The logging cable or drill string 95 includes conductors 99 that connect the downhole electronics 92, 93 with the surface equipment 98 for signal and control communication. Alternatively, these signals may be processed or recorded in the tool 100 and the processed data transmitted to the surface equipment 98 using any means and methods known in the art.

The transducers 92, 93 may be mounted in the tool 100 using various techniques known in the art. The electrical leads can be routed as desired using electronics modules or multiplexers that can drive long cables. Conventional electronics, linking components (e.g., fiber optics), and connectors may be used within the apparatus as known in the art,

One common method for routing or passing wiring, hose, cabling, etc. within a downhole instrument is by forming (e.g., by drilling, machining) a series of “feedthroughs” or passages within the housing walls of the tool or instrument body (which is typically of tubular design as shown in FIG. 1). With this methodology, the more complex system require more complex routing and multiple interconnect feedthroughs to make elaborate turns or form desired angles within the wail or body of the structure. This in turn requires fairly complicated machining and assembly to form enclosed passages,

FIG. 2 shows a side cross section view of a downhole tool 100, including a transducer 200. The transducer 200 is in a recess 312 formed in the tool 100 wall. The transducer 200 is coupled to a bulkhead 310 that ties into a feedthrough 313 for signal/power transmission between the transducer 200 and external components (e.g., electronics, telemetry, memory, etc.) via one or more leads 314 known in the art. A shield 316 is shown covering the transducer.

Electronics and sensors have wires and cables that necessitate the machining or drilling of channels or conduits in tool bodies. However, the need for conduits or channels are not unique to things that are electronic. Many downhole tools handle fluids, including drilling fluids, well treatment or stimulation fluids, and formation fluids. These tools also need conduits for fluid communications. One of such tools is a formation tester used to investigate reservoir pressures and permeabilities, as well as for taking formation fluid samples for analysis.

FIG. 3 shows a cut away view of a downhole tool 100 (a formation tester) deployed in a borehole 14. The tool 100 is provided with various modules and/or components, including a fluid sampling device 26 used to obtain fluid samples from the subsurface formation 19. The fluid sampling device 26 is provided with a probe 28 extendable through the mudcake 15 and to sidewall 17 of the borehole 14 for collecting samples. The samples are drawn into the tool 100 through the probe 28. The sampling system 26 includes an intake section 25 and a flow section 27 for selectively drawing fluids into the desired portion of the downhole tool. The intake section 25 includes a probe 28 mounted on an extendable base 30 having a seal 31, such as a packer, for sealingly engaging the borehole wall 17 around the probe 28. The intake section 25 is selectively extendable from the downhole tool 100 via extension pistons 33. The probe 28 is provided with an interior channel 32 and an exterior channel 34 separated by wall 36. The wall 36 is preferably concentric with the probe 28. However, the geometry of the probe and the corresponding wall may be of any geometry. Additionally, one or more wails 36 may be used in various configurations within the probe.

The flow section 27 includes flow lines 38 and 40 driven by one or more pumps 35. A first flow line 38 is in fluid communication with the interior channel 32, and a second flow line 40 is in fluid communication with the exterior channel 34. The illustrated flow section may include one or more flow control devices, such as the pump 35 and valves 44, 45, 47, and 49 depicted in FIG. 3, for selectively drawing fluid into various portions of the flow section 27. Fluid is drawn from the formation through the interior channels and into their corresponding flow lines. Contaminated fluid may be passed from the formation through exterior channel 34 into flow line 40 and discharged into the wellbore 14. Fluid passes from the formation into the interior channel 32, through flow line 38 and either diverted into one or more sample chambers 42, or discharged into the wellbore. Once it is determined that the fluid passing into flow line 38 is virgin fluid, a valve 44 and/or 49 may be activated using known control techniques by manual and/or automatic operation to divert fluid into the sample chamber.

The fluid sampling system 26 may also include one or more fluid monitoring systems 53 for analyzing the fluid as it enters the probe 28. The fluid monitoring system 53 may include various monitoring devices, such as optical fluid analyzers.

The systems shown in FIGS. 1-3 represent a small fraction of the myriad systems and devices that are disposed in conventional downhole tools. These configurations generally require the formation of voids, passages, chambers, tunnels, and openings within the tool body or portions thereof. As technology advances in the field of manufacturing, the construction and formation of tools and apparatus has become more mechanized. Yet, there remains a need for improved techniques to produce tools and devices to withstand greater environmental stresses while incorporating more intricate and complicated structures.

### SUMMARY OF INVENTION

One aspect of the invention relates to methods for manufacturing a downhole tool. A method in accordance with one embodiment of the invention includes obtaining a three-dimensional model of the downhole tool; converting the three-dimensional model of the downhole tool into a model having a plurality of two-dimensional layers, and building the downhole tool, layer-by-layer, by melting a metal powder or an alloy powder using an electron beam based on the model having a plurality of two-dimensional layers.

One aspect of the invention relates to downhole tools. A downhole tool in accordance with one embodiment of the invention is manufactured by a process that includes obtaining a three-dimensional model of the downhole tool; converting the three-dimensional model of the downhole tool into a model having a plurality of two-dimensional layers; and building the downhole tool, layer-by-layer, by melting a metal powder or an alloy powder using an electron beam based on the model having a plurality of two-dimensional layers.

Other aspects and advantages of the invention will be apparent from the following description and the appended claims.

### BRIEF DESCRIPTION OF DRAWINGS

FIG. 1 shows a conventional electromagnetic logging tool disposed in a borehole.

FIG. 2 shows a cross section of a conventional downhole tool illustrating a transducer disposed in a chamber created in a section of the tool body.

FIG. 3 shows a downhole fluid sampling tool disposed in a borehole.

FIG. 4 shows a downhole tool manufactured with a method in accordance with one embodiment of the invention.

FIG. 5A shows a tool section having a curved channel therein manufactured using a method of the invention.

FIG. 5B shows a tool section similar to that of FIG. 5A, but manufactured using conventional machining processes.

FIGS. 6A-6C show a series of schematics illustrating a method of invention for manufacturing a downhole tool.

FIG. 7 shows flow chart illustrating a method in accordance with one embodiment of the invention.

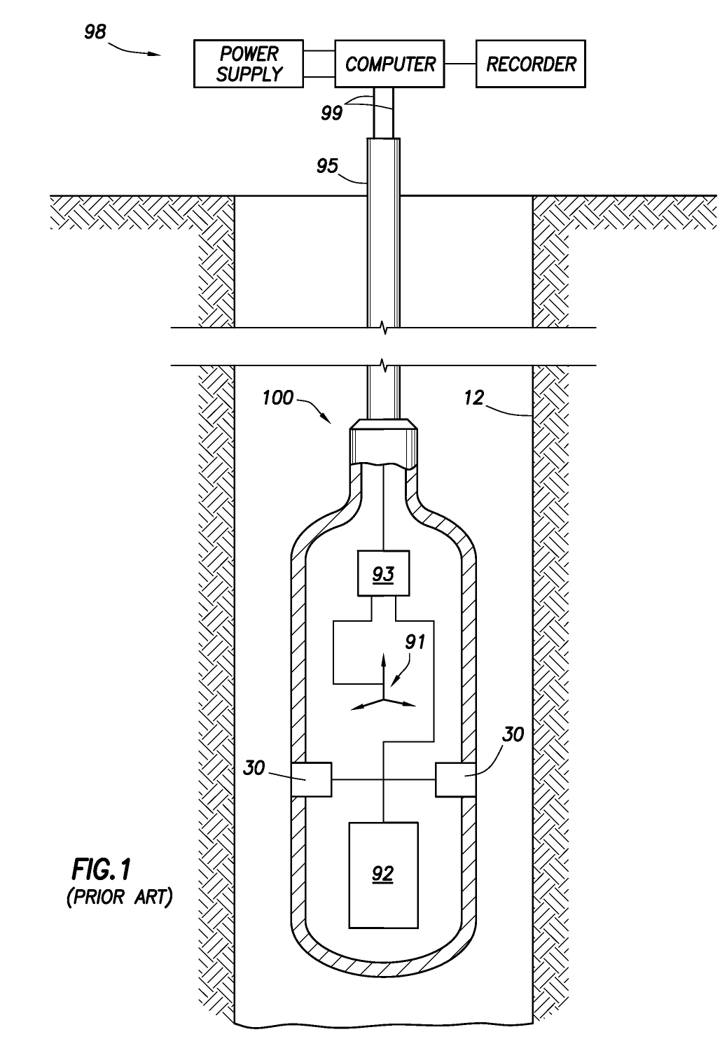

### DETAILED DESCRIPTION

Embodiments of the invention relate to methods for manufacturing downhole tools and tools made with these methods. “Downhole tool” in this description is used in a broad sense to include a portion of a device/tool or a complete device/tool. A method in accordance with embodiments of the invention builds, from the starting materials, the tool structures that incorporate one or more feedthroughs, passages, channels, chambers, etc. in the tool structures during the manufacturing processes, rather than afterwards.

Embodiments of the invention relate to new techniques for producing tools and apparatus, particularly tools and apparatus for use in the oilfield industry, using an improved fabrication technology to produce fully dense parts from metal powder. Methods in accordance with embodiments of the invention are based on the electron beam melting (EBM) technology.

EBM is a freeform fabrication technique for manufacturing solid metal objects directly from metal or alloy powders (e.g., titanium powder) based on a computer file (CAD file) that describes the three-dimensional structure of the object. The CAD structure is sliced into a series of two-dimensional layers having a thickness less than 1 mm, typically ranging from 0.05-0.2 mm. The electron beam is then used to melt the metal powder according to the two-dimensional pattern. The process is repeated for all the layers to finally build the desired three-dimensional structure.

The process uses a high power (typically around 7 KW on average) electron beam that is 95 percent efficient—5 to 10 times more efficient than laser beam melting. With laser-based systems, 95 percent of the light energy is reflected by the powder rather than absorbed, resulting in a low efficiency. The high efficiency of EBM makes it possible to create metal parts 3 to 5 times faster than other metal additive-fabrication methods.

EBM can use metal powders or alloy powders. Titanium is the most common metal powder used in EBM Other suitable metal powders, for example, may include various steels, such as H13 tool steel, 17-4PH stainless steel, 316 stainless steel, and Arcam® Low Alloy Steel). Suitable alloy powders, for example, may include: nickel-based superalloys (such as Inconel®625, 690, and 718), Ti6AL4V (ASTM F136; grade 5), TI6AL4V ELI (ASTM F136; grade 23), CoCr alloy (ASTM F75). Ti6Al4V is a titanium based alloy containing about 6% Aluminum and about 4% vanadium. CoCr alloy is a cobalt-chromium alloy. Other metals may also be added to these alloys to improve their properties. For example, addition of 0.05% palladium (grade 24), 0.1% ruthenium (grade 29), and 0.05% palladium and 0.5% nickel (grade 25) can significantly increase their corrosion resistance in reducing acid, chloride and sour environments.

In accordance with embodiments of the invention, tools or apparatus of the invention may be produced using any commercially available CAD-EBM technologies, such as the CAD to Metal technology from Arcam AB of Sweden.

Embodiments of the invention use the CAD-EBM technology to produce parts in solid metal. Final machining of parts, if necessary, may be performed with any conventional methods such as high-speed milling, turning, grinding, EDM, etc. Thus, tools or apparatus in accordance with embodiments of the invention include those produced directly from the CAD-EBM and those that have been further machined after the CAD-EBM process.

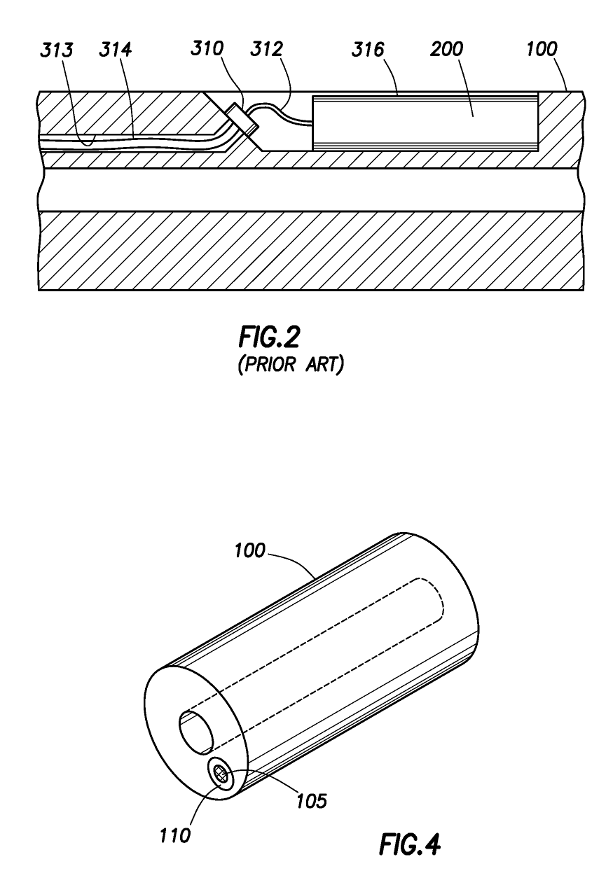

FIG. 4 shows a schematic illustrating one embodiment of the invention, in the cross-sectional view shown in FIG. 4, a tool 100 is formed as a metallic tubular, including a fully sealed chamber 105 formed in the wall and housing a substance/device 110. In accordance with some embodiments of the invention, the substance/device 110 may be a source (such as a radioactive source), a sensor, a transducer, or any desired component. The fully enclosed chamber 105 will be impossible to create with the conventional machining. In accordance with embodiments of the invention, the tool 100 may be formed by building up the solid metal structure by layering the metal powder, where the metal powder in each layer is melted by an electron beam to the exact geometry defined by a computer model (a CAD file),

In accordance with embodiments of the invention, the tool 100 is first designed in a 3 CAD (computer aided design) program. The file is then transferred to processing software where the model is sliced into a series of thin layers. The tool 100 is built layer-by-layer using the EBM process in a vacuum chamber (not shown) under controlled conditions (e.g., temperature control). When the CAD-EBM process is complete, the tool 100 may be cleaned and finished as needed using conventional machining methods. The combination of EBM in a vacuum provides a high power process and a good environment, resulting in excellent material properties. Embodiments of the invention can be produced using different types of metals and alloys provided they are suitable for the CAD-EBM process.

FIG. 4 illustrates that a completely enclosed chamber 105 can be readily constructed using a CAD-EBM process of the invention. Such a completely enclosed chamber would be very difficult, if not impossible, to construct using the conventional machining process. Similarly, a CAD-EBM process of the invention may also be used to construct curved passage in a solid body without difficulty. In contrast, to construct a curved passage in a solid body using conventional machining processes would be rather cumbersome.

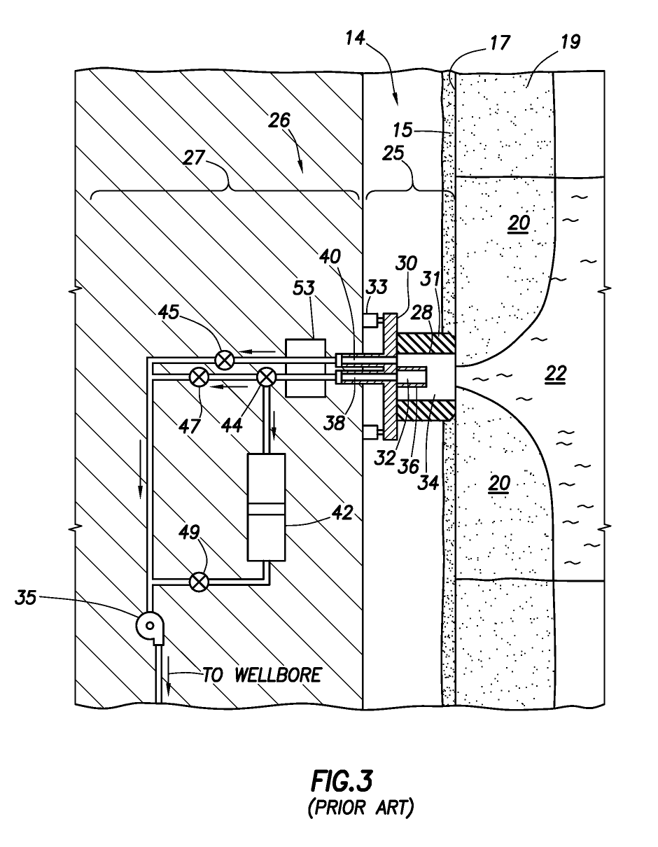

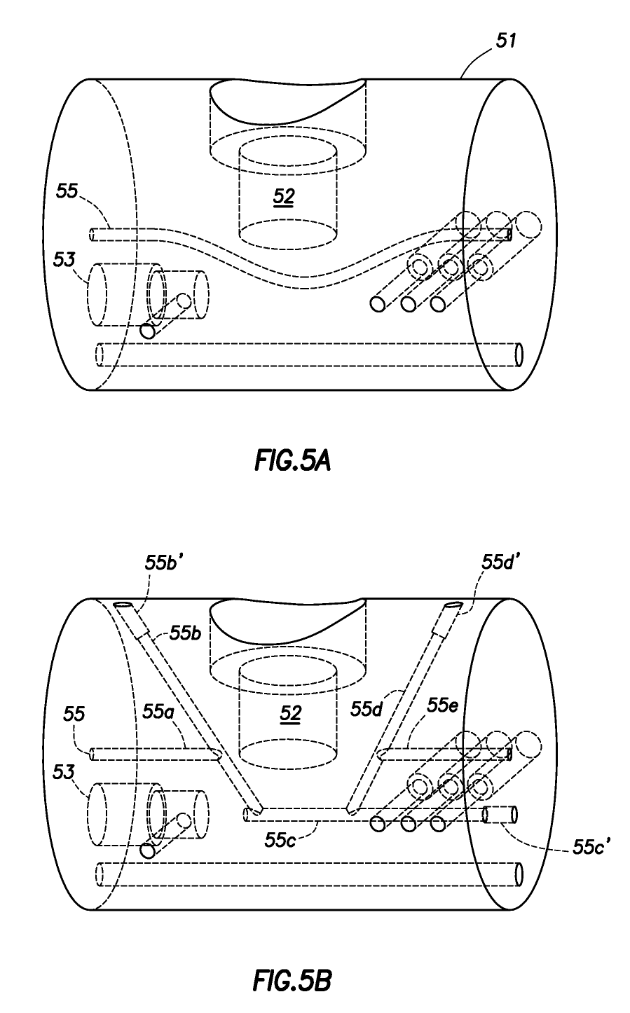

FIG. 5A shows a solid section of a tool 51, which includes a curved channel 55 that runs from, one end of the tool section to the other end, while avoiding two internal structures 52 and 53. The curved channel 55 within the tool section 51 can be readily manufactured using a CAD-EBM process of the invention. Such a curved passage would not be possible using conventional machining processes.

Instead, such a curved passage would have to be drilled in several linear sections 55a-55e that are joined to form a zigzagged passage in order to bypass the internal structures 52 and 53, as shown in FIG. 5B. In addition, the openings of the linear drilled sections 55b, 55c, and 55d would need to be capped (shown as 55b′, 55c′, and 55d′) after machining. The whole process would be very cumbersome.

As illustrated in the above examples, a CAD-EBM process of the invention works

directly from CAD files (more precisely, serially sliced (layered) CAD files). Such a CAD-EBM process increases the speed of manufacturing and allows for the production of tools and apparatus with complex geometries or structures, such as fully sealed cavities within a solid body, or intricate feedthrough channels which may be completely sealed and internal to a tool body (see FIGS. 4 and 5A).

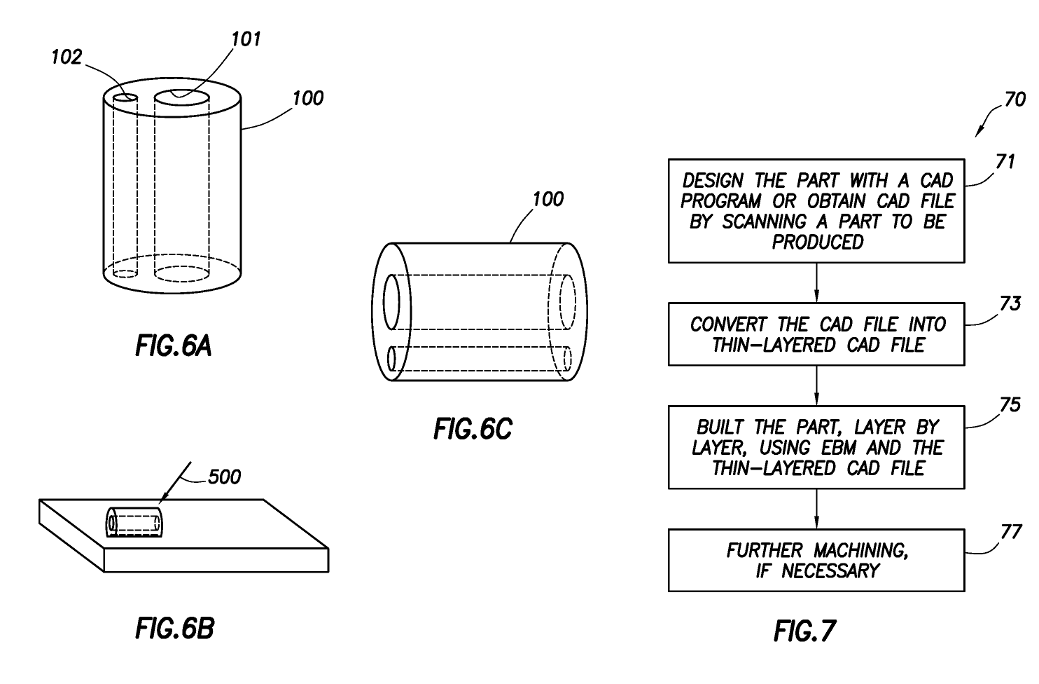

FIGS. 6A-6C illustrate a process for manufacturing an apparatus or tool in accordance with one embodiment of the invention. FIG. 6A shows a tool 100, which includes two channels 101 and 102, to be designed in a 3D CAD program. The tool 100 model is sliced in a series of thin layers (typical thickness ranging from 0.02-0.5 mm) to create a model tile that comprises multiple 2D layers. Based on these multiple 2D layers, the 3D object will be built, layer-by-1 aver, using electron beam to melt metal or alloy powders.

In an EBM process, the metal or alloy powder Is raked onto a vertically adjustable surface in an even, thin layer. The first layer's geometry is then created in the layer of powder by melting together metal powders at points specified by the CAD file. The melting is accomplished by a computer controlled electron beam (shown as 500 in FIG. 6B). After the layer is finished, the building surface is lowered by a distance equal to the thickness of the powder layer, and the next layer of powder is placed on top of the previous layer, as shown in FIG. 6B. The procedure is repeated so that the tool 100 as defined in the CAD model is shaped, layer by layer, until a finished metal part is completed, as shown in FIG. 6C.

FIG. 7 shows a flow chart illustrating a general method in accordance with embodiments of the invention. As shown, a method 70 starts with designing a part, (a tool or an apparatus) using a computer aided design (CAD) program or by scanning an existing object to obtain a CAD file (step 71). Any of the commercially available CAD or 3D scanning programs may be used for the design. The CAD file is then processed to produce a thin-layered CAD file, i.e., a CAD file representing the 3D object as a series of thin 2D layers (step 73). Again, any suitable commercial program, may be used for this. With some commercial CAD-EBM systems, the programs needed for steps 71 and 73 may be included in the system (see for example, the CAD to Metal system from Arcam AB).

Then, the part is built, layer by layer, using EBM and the CAD file (step 75), as described above with reference to FIG. 6B. The part may be built with a suitable metal powder (e.g., titanium) or alloy that is compatible with the EBM process. The layer-by-layer process is repeated until the desired part is constructed. Thereafter, the finished part may be further machined, if necessary (step 77). Such further machining may employ any conventional techniques.

Advantages of the present invention include one or more of the following. The metal objects manufactured by EBM, in accordance with embodiments of the invention, are fully solid objects. They are devoid of voids and are, therefore, very strong. In addition, more intricate tools or apparatus may be manufactured with embodiments of the invention, including completely enclosed chamber in a solid part or complex channels or feedthroughs in a tool body. In addition to being able to produce stronger tools or apparatus, the CAD-EBM methodology in accordance with embodiments of the invention can produce a desired tool or apparatus much faster than conventional methods.

Embodiments of the invention are applicable to various field of use, not just oilfield use. The fabrication of the downhole tools is one exemplary application of methods of the invention. Those skilled in the art would appreciate that all types of sources, sensors, electronics, materials, components, and many other devices may be included in a tool or apparatus of the invention. Such tools or apparatus may be used in all areas of oilfield applications. Including completion/production, wireline or while-drilling applications.

While the invention has been described with respect to a limited number of embodiments, those skilled in the art, having benefit of this disclosure, will appreciate that other embodiments can be envisioned that do not depart from the scope of the invention as disclosed herein. Accordingly, the scope of the invention shall be limited only by the attached claims.

What is claimed is:

1. A method for manufacturing a downhole tool, comprising:
obtaining a three-dimensional model of the downhole tool;
converting the three-dimensional model of the downhole tool into a model having a plurality of two-dimensional layers; and
building the downhole tool, layer-by-layer, by melting a metal powder or an alloy powder using an electron beam based on the model having a plurality of two-dimensional layers.

2. The method of claim 1, further comprising machining the downhole tool that has been built using the electron beam.

3. The method of claim 1, wherein the downhole tool comprises a chamber enclosed by a metal body.

4. The method of claim 1, wherein the three-dimensional model of the downhole tool is designed using a computer-aided design (CAD) program.

5. The method of claim 1, wherein the three-dimensional model of the downhole tool is derived from scanning an existing tool.

6. The method of claim 1, wherein the metal powder is a titanium or steel powder.

7. The method of claim 6, wherein the steel powder is an H13 tool steel powder, a 17-4PH stainless steel powder, or a 316 stainless steel powder.

8. The method of claim 1, wherein the metal alloy powder is a titanium, chromium, or nickel alloy powder.

9. The method of claim 8, wherein the titanium alloy powder is Ti6AL4V or Ti6AL-4V ELI.

10. A downhole tool manufactured by a process comprising:
obtaining a three-dimensional model of the downhole tool;
converting the three-dimensional model of the downhole tool into a model having a plurality of two-dimensional layers; and
building the downhole tool, layer-by-layer, by melting a metal powder or an alloy powder using an electron beam based on the model having a plurality of two-dimensional layers.

11. The downhole tool of claim 10, comprising a chamber enclosed in a tool body.
